(19) United States
(12) Patent Application Publication
(10) Pub. No.: US 2014/0003612 A1
(43) Pub. Date: Jan. 2, 2014

(54) INFORMATION TERMINAL AND COMPUTER PROGRAM PRODUCT

(71) Applicant: Kabushiki Kaisha Toshiba, Tokyo (JP)

(72) Inventors: Kazuyuki Saito, Tokyo (JP); Koichi Kaji, Saitama (JP); Takashi Sudo, Tokyo (JP)

(73) Assignee: Kabushiki Kaisha Toshiba, Tokyo (JP)

(21) Appl. No.: 14/018,592

(22) Filed: Sep. 5, 2013

Related U.S. Application Data
(63) Continuation of application No. PCT/JP2013/057948, filed on Mar. 13, 2013.

(30) Foreign Application Priority Data
May 30, 2012 (JP) 2012-123483

(51) Int. Cl. G10K 11/00

(52) U.S. Cl. CPC G10K 11/002
USPC 381/66

(57) ABSTRACT

According to one embodiment, information terminal includes: first audio input module; first audio output module; second audio input module; audio processor; and second audio output module. The first audio input module receives an external sound from an external information terminal connected to the information terminal via an external network. The first audio output module outputs the external sound. The second audio input module receives sounds transmitted from a sound input device of each information terminal within a group connected to the information terminal via the internal network. The audio processor synthesizes the in-group sounds to generate a single input sound, and removes an echo component from the input sound. Here, the echo component is caused due to the external sounds output from the sound output device. The second audio output module outputs the input sound from which the echo component is removed to the external information terminal.

### CROSS-REFERENCE TO RELATED APPLICATIONS

This application is a continuation of PCT international application Ser. No. PCT/JP2013/057948, filed Mar. 13, 2013, which designates the United States, incorporated herein by reference, and which is based upon and claims the benefit of priority from Japanese Patent Application No. 2012-123483, filed May 30, 2012, the entire contents of which are incorporated herein by reference.

### FIELD

Embodiments described herein relate generally to an information terminal and a computer program product.

### BACKGROUND

Conventionally, there has been known a telephone system as means for performing interpersonal communications. In recent years, along with the improvements of network technologies, the interpersonal communication has been developed into a system that uses not only a sound but also a video, i.e., teleconferencing system.

The conventional teleconferencing system provides a dedicated device (a communication controller such as a set top box), a microphone and a camera in a teleconference room at each branch (office or the like) located at various locations, and the branches are connected to each other via an IP exclusive line, thereby communicating sounds and videos.

In recent years, there has been developed a system that can easily construct a inter-multiple points teleconferencing system by introducing a client software for teleconference into an information terminal such as a notebook PC or a tablet terminal.

However, in view of a case when the teleconference is performed by using the information terminal such as a notebook-type portable personal computer (the notebook PC) or the tablet terminal, when participants gathered in a teleconference room use a speakerphone function of their own information terminals, echo or howling occurs due to sounds generated from the information terminal adjacent to each other.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic view of a computer in a state in which a display module of the computer is opened, according to an embodiment;

FIG. 2 is an exemplary block diagram of a system configuration of the computer in the embodiment;

FIG. 3 is an exemplary system configuration view of a network configuration in a case in which a teleconference is performed among a plurality of computers, in the embodiment;

FIG. 4 is an exemplary functional block diagram of a phone function in the embodiment;

FIG. 5 is an exemplary front view of a selection screen in the embodiment;

FIG. 6 is an exemplary block diagram of a functional configuration of an audio processor in the embodiment.

### DETAILED DESCRIPTION

In general, according to one embodiment, an information terminal comprises: a first audio input module; a first audio output module; a second audio input module; an audio processor; and a second audio output module. The first audio input module is configured to receive an external sound transmitted through an external network from an external information terminal connected to the information terminal via the external network. The first audio output module is configured to output the external sound received by the first audio input module from a sound output device. The second audio input module is configured to receive sounds transmitted through an internal network from a sound input device of each information terminal within a group connected to the information terminal via the internal network. The audio processor is configured to synthesize the in-group sounds received from the each information terminal within the group by the second audio input module to generate a single input sound, and to remove an echo component from the input sound. Here, the echo component is caused due to the external sounds output from the sound output device. The second audio output module is configured to output the input sound from which the echo component is removed to the external information terminal via the external network.

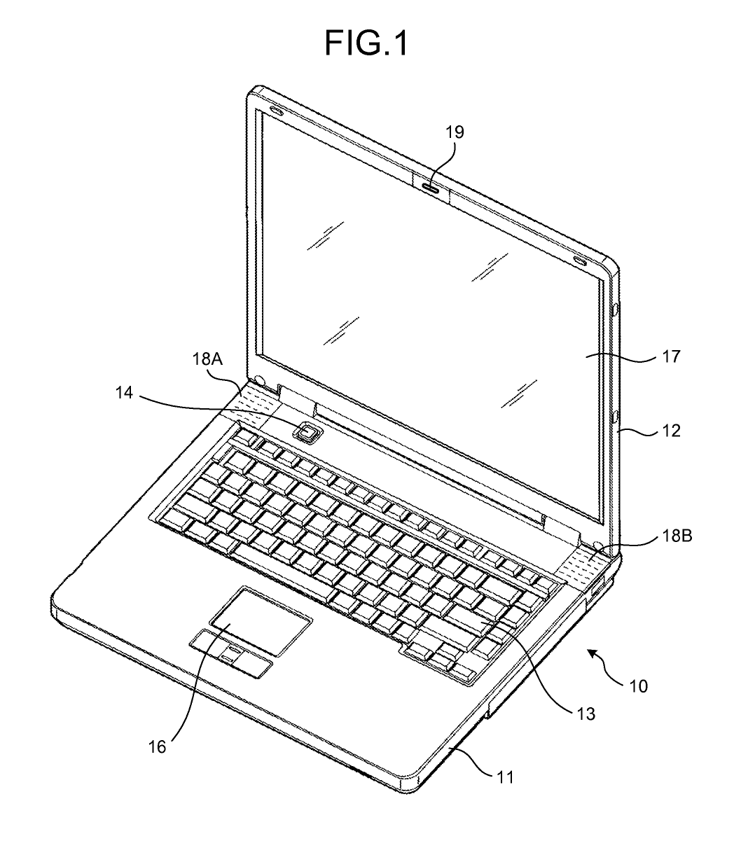

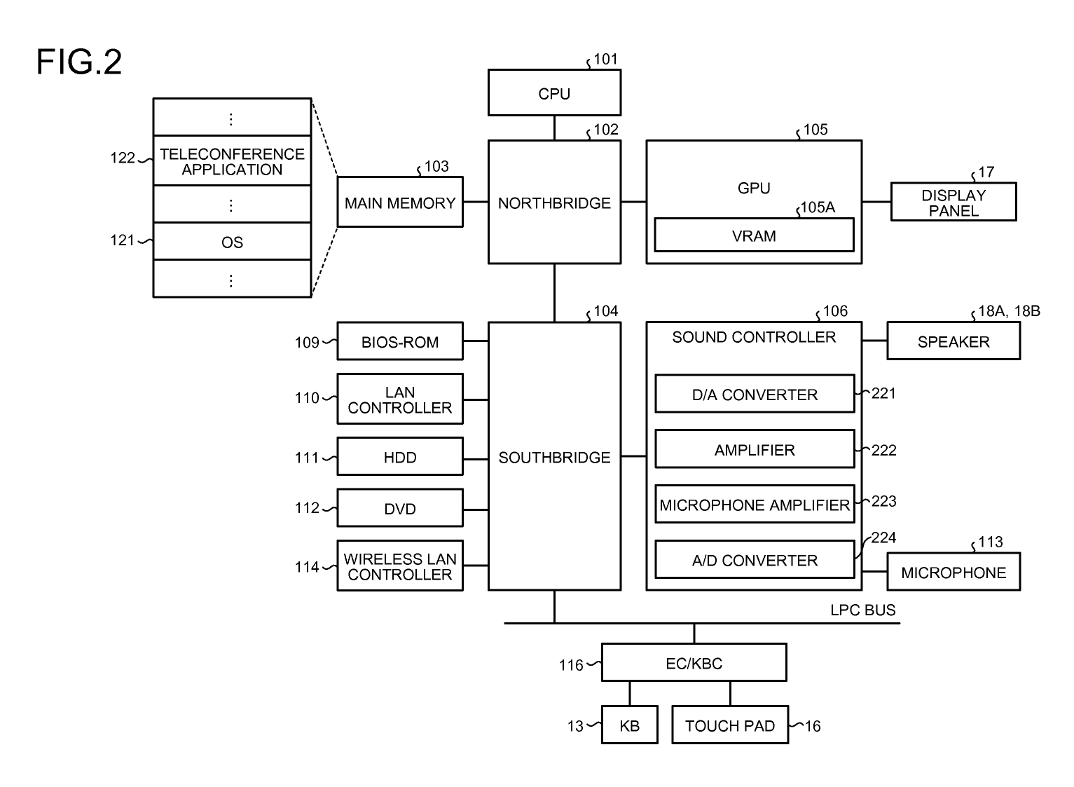

Hereinafter, an embodiment is explained in conjunction with drawings. First of all, a configuration of an information terminal is explained in conjunction with FIGS. 1 and 2. The information terminal in the present embodiment is realized by, for example, a notebook-type portable personal computer. Here, the present embodiment is not limited to the notebook-type portable personal computer as the information terminal, and can also be applied to a tablet terminal, a smart phone, or the like.

FIG. 1 is a schematic view of a notebook-type portable personal computer 10 in a state in which a display module 12 thereof is opened. The notebook-type portable personal computer 10 (hereinafter, referred to as the computer 10) comprises a computer body 11 and the display module 12.

The display module 12 incorporates therein a display panel 17 comprising a liquid crystal panel. The display module 12 is provided with a microphone 113 (see FIG. 2) that is an audio input device. The display module 12 is provided with a microphone hole 19 for efficiently collecting a sound by the microphone 113.

The display module 12 is attached to the computer body 11 in such a manner that the display module 12 can be rotated between an open position at which the upper surface of the computer body 11 is exposed and a closed position at which the upper surface of the computer body 11 is covered with the display module 12. The computer body 11 has a casing formed in a thin box shape, and is arranged with a keyboard 13, a power button 14 for turning on and off the computer 10, a touch pad 16, speakers 18A and 18B that are sound output devices, and the like on the upper surface thereof.

Next, the system configuration of the computer 10 is explained in conjunction with FIG. 2. The computer 10 comprises, as illustrated in FIG. 2, a CPU 101, a northbridge 102, a main memory 103, a southbridge 104, a graphic processing unit (GPU) 105, a video memory (VRAM) 105A, a sound controller 106, a BIOS-ROM 109, a LAN controller 110, a wireless LAN controller 114, a hard disk drive (HDD) 111, a DVD drive (DVD) 112, an embedded controller/keyboard controller IC (EC/KBC) 116, and the like.

The CPU 101 is a processor for controlling the operation of the computer 10, and executes an operating system (OS) 121 and various kinds of application programs such as a teleconference application 122 that are loaded from the hard disk drive (HDD) 111 into the main memory 103. The teleconference application 122 is an application software for executing a teleconference function. Furthermore, the CPU 101 also executes a basic input output system (BIOS) stored in the BIOS-ROM 109. The BIOS is a computer program for hardware control.

The northbridge 102 is abridge device for connecting between the local bus of the CPU 101 and the southbridge 104. The northbridge 102 also incorporates therein a memory controller for access control of the main memory 103. Furthermore, the northbridge 102 also comprises a function for communicating with the GPU 105 via a serial bus or the like compatible with the PCI Express standard.

The GPU 105 is a display controller for controlling the display panel 17 used as the display monitor of the computer 10. The GPU 105 uses the VRAM 105A as a work memory. Video signals generated by the GPU 105 are transmitted to the display panel 17.

The southbridge 104 controls each device on a low pin count (LPC) bus and each device on a peripheral component interface (PCI) bus. The southbridge 104 realizes a local area network (LAN) function and a wireless LAN function by controlling the LAN controller 110 and the wireless LAN controller 114. Furthermore, the southbridge 104 incorporates therein an integrated drive electronics (IDE) controller for controlling the hard disk drive (HDD) 111 and the DVD drive 112. In addition, the southbridge 104 comprises a function for communicating with the sound controller 106. The sound controller 106 is a sound source device, and comprises circuits of a digital to analog (D/A) converter (circuit) 221 for converting digital signals into electrical signals, an amplifier 222 for amplifying electrical signals, and the like for outputting audio data to be reproduced to the speakers 18A and 18B. Furthermore, the sound controller 106 comprises circuits such as a microphone amplifier 223 for amplifying electrical signals input from the microphone 113 and an analog to digital (A/D) converter (circuit) 224 for converting electrical signals amplified into digital signals.

The embedded controller/keyboard controller IC (EC/KBC) 116 is a one-chip microcomputer into which an embedded controller for control of electric power and a keyboard controller for controlling the keyboard (KB) 13 and the touch pad 16 are integrated. The embedded controller/keyboard controller IC (EC/KBC) 116 comprises a function for turning on and off the computer 10 in response to the operation of the power button 14 by a user.

Next, the configuration of teleconferencing system 100 for communicating among many branches by using the computers 10 is explained.

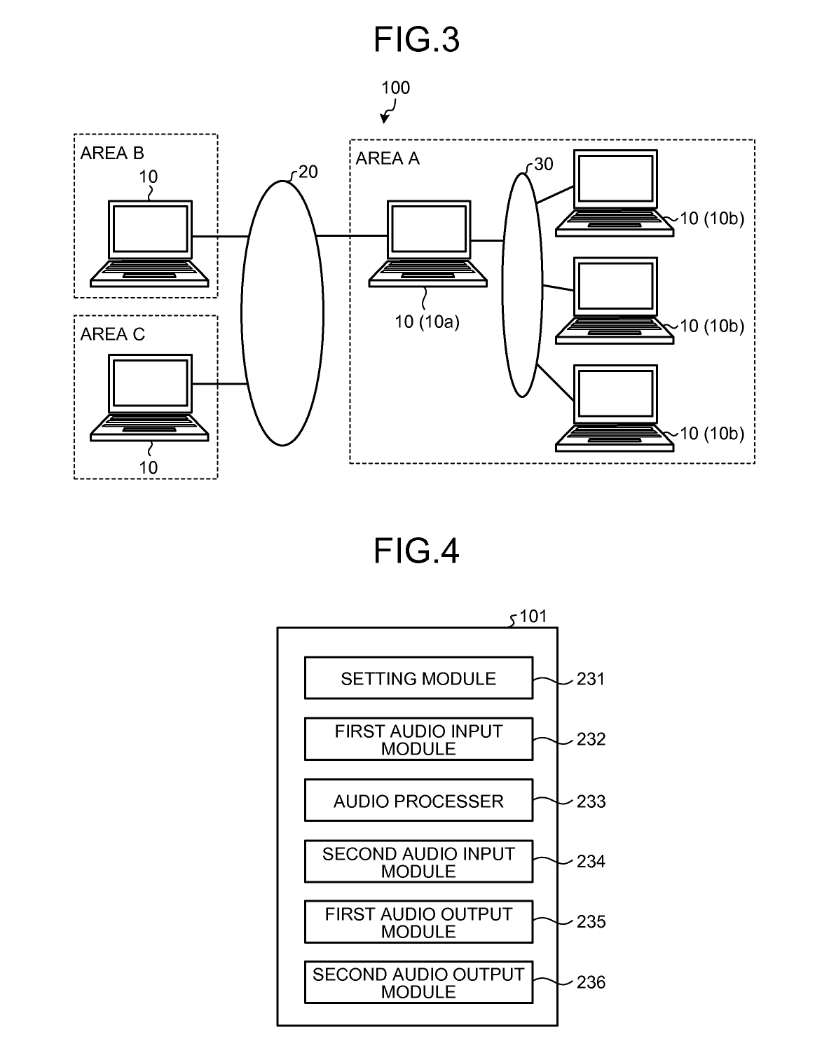

FIG. 3 illustrates a network configuration example for the case in which a teleconference is performed among a plurality of such computers 10 in the present embodiment. The example illustrated in FIG. 3 is an example for the case in which the teleconference is performed among three areas, namely, among an area A, an area B and an area C. Four computers 10, which are information terminals in a same group, belong to the area A. One computer 10, which is an external information terminal, belongs to the area B, whereas another computer 10, which is also an external information terminal, belongs to the area C.

In the teleconferencing system 100 illustrated in FIG. 3, each computer 10 in the area B and the area C and one computer 10 (hereinafter, referred to as a master terminal 10a) are connected with each other via a network 20 that is an external network such as an IP virtual private network (IP-VAN) utilizing an IP network. Furthermore, in the area A, the computers 10 other than the master terminal 10a (hereinafter, referred to as slave terminals 10b) are connected with the master terminal 10a via a wireless LAN 30 that is a local internal network for transmitting and receiving data by using wireless communications.

Next, phone capabilities of the teleconference application 122 is explained in reference to a functional block diagram illustrated in FIG. 4. The teleconference application 122 is loaded from the hard disk drive (HDD) 111 into the main memory 103 by the CPU 101 and executed. As a result, as illustrated in FIG. 4, the CPU 101 of the computer 10 functions as a setting module 231, a first audio input module 232, an audio processor 233, a second audio input module 234, a first audio output module 235, and a second audio output module 236 that are related to the phone capabilities, in accordance with the teleconference application 122.

The setting module 231 specifies one of the computers 10 located adjacent to each other within a range in which sounds can directly and acoustically reach others as the master terminal 10a, and specifies other computers 10 as the slave terminals 10b. To be more specific, the setting module 231 displays a selection screen P illustrated in FIG. 5 on the display panel 17, and specifies each computer 10 as the master terminal 10a or the slave terminal 10b. As illustrated in FIG. 5, the selection screen P displays thereon radio buttons B1 for selecting whether the computer 10 functions as “the master terminal” or functions as “the slave terminal”. Each computer 10 sets therein a function corresponding to each radio button B1 selected by operating the keyboard (KB) 13 or the touch pad 16.

Only when the computer 10 is, as mentioned above, specified as the master terminal 10a by the setting module 231, the first audio input module 232, the audio processor 233, the second audio input module 234, the first audio output module 235, and the second audio output module 236 become effective.

The first audio input module 232 receives, via the LAN controller 110, external sounds (the voice of an owner of the computer 10, for example) transmitted from the computer 10 in the other area (the area B or the area C, for example) via the network 20. The first audio output module 235 outputs the external sounds input to the first audio input module 232 to the speakers 18A and 18B each of which is a sound output device via the sound controller 106. Due to such configuration, the owner of the master terminal 10a and the owner of the slave terminal 10b in the area A can hear the sounds (e.g., the voice of the owner of the computer 10) from the other area (e.g., the area B or the area C, for example) as the voice of a communication partner. That is, the sounds (the voice of the owner of the computer 10, for example) transmitted from the computer 10 in the other area (the area B or the area C, for example) via the network 20 and received via the LAN controller 110 are output only from the speakers 18A and 18B of the master terminal 10a in the area A, and not output from the slave terminal 10b in the area A.

The second audio input module 234 receives the input sounds (the voice of the owner of the computer 10, for example) transmitted from the microphone 113 of each slave terminal 10b in the area A via the wireless LAN 30 and transferred via the wireless LAN controller 114, and outputs the sounds to the audio processor 233.

Here, when the sounds output from the speakers 18A and 18B of the master terminal 10a in the area A are input to the microphone 113 of the master terminal 10a and the microphone 113 of the slave terminal 10b in the area A, echo occurs.

Thus, the audio processor 233 synthesizes input sounds transmitted from the microphone 113 of the master terminal 10a and the microphone 113 of the slave terminal 10b in the area A to generate a single input sound, and removes an echo component from the input sound. The second audio output module 236 transfers the input sound from which the echo component is removed by the audio processor 233 to the computer 10 in the other area (the area B or the area C, for example) via the network 20. This mechanism is generally referred to as an acoustic echo canceller.

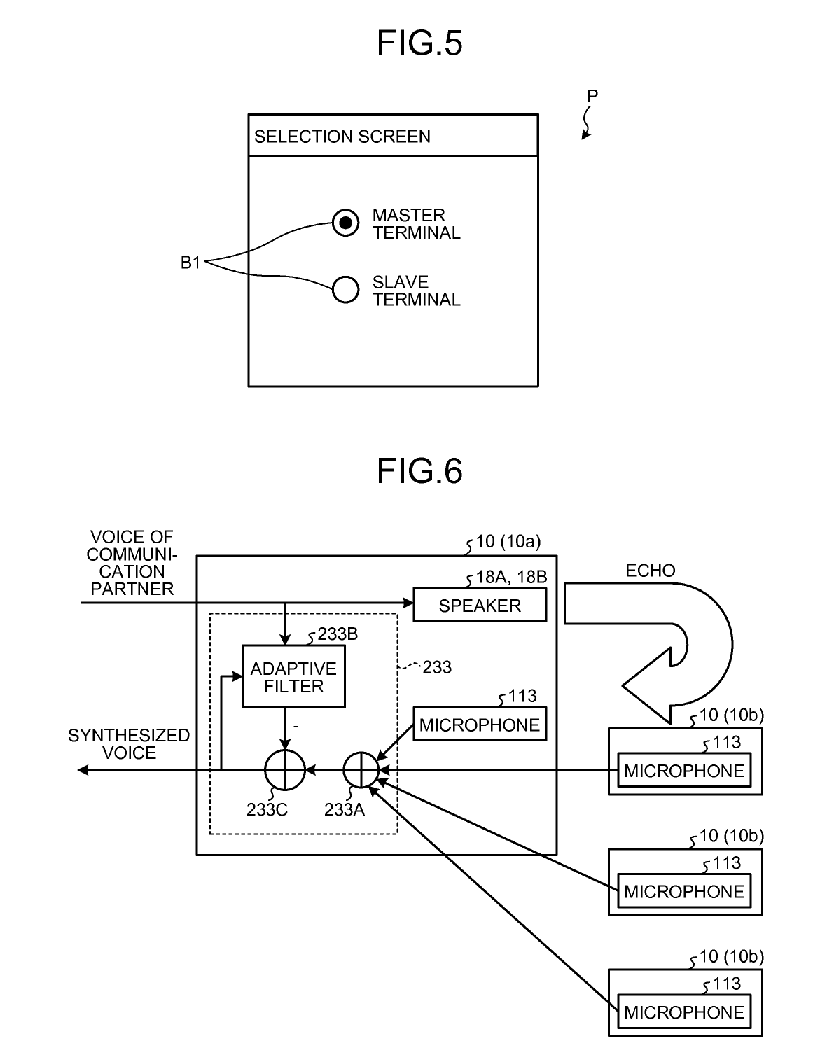

Here, FIG. 6 is a block diagram illustrating the functional configuration of the audio processor 233. As illustrated in FIG. 6, the audio processor 233 comprises an adder 233A, an adaptive filter 233B, and an adder 233C.

The adder 233A is a first adder, and synthesizes the sound signal from the microphone 113 of the master terminal and the sound signal from the microphone 113 of each slave terminal 10b in the area A to generate a single sound signal. The sound signal synthesized in this manner contains the echo component of sound output from the speakers 18A and 18B of the master terminal 10a, propagated in the air, and input to the microphone 113 of the master terminal 10a or the microphone 113 of each slave terminal 10b.

The adaptive filter 233B is a filter for self-adapting a transfer function of the speakers 18A and 18B and the microphone 113 in accordance with an optimization algorithm. That is to say, the adaptive filter 233B is operated so as to minimize an echo component, which is due to a communication partner's voice output from the speakers 18A and 18B, with reference to the sound (the voice of the owner of the computer 10, for example) transmitted from the computer 10 in the other area (e.g., the area B or the area C) via the network 20 and received via the LAN controller 110.

The adder 233C is a second adder for removing the echo component, which is due to a communication partner's voice output from the speakers 18A and 18B, by subtracting an antiphase of the sound transferred from the computer 10 in the other area (the area B or the area C, for example) through the adaptive filter 233B from the sound synthesized in the adder 233A.

Therefore, when the computers 10 as the information terminals are, for example, adjacent to each other so as to be located within a range in which sounds can directly reach each other, one of such computers 10 is set as the master terminal 10a and, at the same time, the other computers 10 are set as the slave terminals 10b. The master terminal 10a is connected with the slave terminals 10b via the wireless LAN 30 that is a local network and, at the same time, only the master terminal 10a is connected with the teleconferencing system (the computer 10) located at a distant place via the global network 20. The sound transmitted from the distantly located computer 10 is output only from the speakers 18A and 18B of the master terminal 10a, and is not output from the slave terminals 10b.

Furthermore, the sounds input from the microphone 113 of the slave terminal 10b are transferred to the master terminal 10a. That is, each of the slave terminals 10b is used only for receiving sounds from the microphone 113, and the sound is only output from the speakers 18A and 18B of the master terminal 10a. In addition, the master terminal 10a synthesizes the microphone's input sounds transferred from the slave terminal 10b via the wireless LAN 30 in the adder 233A to generate a single input sound, removes the echo component by an echo cancellation function and thereafter, transfers the sound to the distantly located computers 10, thereby preventing howling or echo occurred between the information terminals adjacent to each other.

In this manner, according to the present embodiment, the teleconference can be performed by using the microphone 113 of the computer 10 of each individual, thereby a distance between the microphone 113 and a user can be set shorter than in the case in which a single equipment is used in the teleconferencing system. Accordingly, the input sound becomes clearer. Furthermore, when there are a plurality of such computers 10 located adjacent to each other within a range so that the sounds can directly be heard by each other, the teleconference can be performed with the use of a speakerphone without the occurrence of howling or echo. In addition, the microphone 113 mounted on the computer 10 can be used, thereby it is unnecessary to provide dedicated headsets or the like for all participants.

The teleconference application 122 executed in the computer 10 in the present embodiment is provided in the form of an installable format file or an executable format file recorded in a computer-readable recording medium such as a compact disc-read only memory (CD-ROM), a flexible disk (FD), a compact disk recordable (CD-R), or a digital versatile disk (DVD).

Furthermore, the teleconference application 122 executed in the computer 10 in the present embodiment may be stored on the computer connected to a network such as the Internet and provided by being downloaded via the network. The teleconference application 122 executed in the computer 10 in the present embodiment may be provided or distributed via a network such as the Internet. In addition, the teleconference application 122 in the present embodiment may be incorporated in a read only memory (ROM) or the like in advance and provided.

The teleconference application 122 executed in the computer 10 in the present embodiment is constituted of modules including the above mentioned modules (the setting module 231, the first audio input module 232, the audio processor 233, the second audio input module 234, the first audio output module 235, and the second audio output module 236). As actual hardware, the processor (CPU) 101 reads out the teleconference application 122 from the above-mentioned recording medium to execute whereby the above-mentioned modules are loaded on the main memory, and the setting module 231, the first audio input module 232, the audio processor 233, the second audio input module 234, the first audio output module 235, and the second audio output module 236 are generated on the main memory.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information terminal comprising:
a first audio input module configured to receive an external sound transmitted through an external network from an external information terminal connected to the information terminal via the external network;
a first audio output module configured to output the external sound received by the first audio input module from a sound output device;
a second audio input module configured to receive sounds transmitted through an internal network from a sound input device of each information terminal within a group connected to the information terminal via the internal network;
an audio processor configured to synthesize the in-group sounds received from the each information terminal within the group by the second audio input module to generate a single input sound, and to remove an echo component from the input sound, the echo component being caused due to the external sounds output from the sound output device; and
a second audio output module configured to output the input sound from which the echo component is removed to the external information terminal via the external network.

2. The information terminal of claim 1, wherein the audio processor comprises:
a first adder configured to synthesize the in-group sounds received from the sound input device of the each information terminal within the group to generate the single input sound;
an adaptive filter configured to be operated so as to self-adapt a transfer function of the sound output device and the sound input device to minimize the echo component, with reference to the external sound transmitted through the external network; and
a second adder configured to subtract an antiphase of the external sound processed through the adaptive filter from the input sound synthesized by the first adder.

3. The information terminal of claim 1, further comprising a setting module configured to specify whether to cause the each information terminal within the group connected via the internal network to function as a master terminal or a slave terminal configured to transmit a sound from the sound input device to the master terminal via the internal network, wherein
the master terminal comprises the first audio input module, the first audio output module, the second audio input module, the audio processor, and the second audio output module, and
the slave terminal comprises none of the first audio input module, the first audio output module, the second audio input module, the audio processor, and the second audio output module.

4. A computer program product having a non-transitory computer readable medium including programmed instructions, wherein the instructions, when executed by a computer, cause the computer to perform:
first receiving an external sound transmitted through an external network from an external information terminal connected to an information terminal via the external network;
first outputting the external sound received by the first receiving from a sound output device;
second receiving sounds transmitted through an internal network from a sound input device of each information terminal within a group connected to the information terminal via the internal network;
synthesizing the in-group sounds received from the each information terminal within the group by the second receiving to generate a single input sound;
removing an echo component from the input sound, the echo component being caused due to the external sounds output from the sound output device; and
second outputting the input sound from which the echo component is removed to the external information terminal via the external network.

5. The computer program product of claim 4, wherein the synthesizing synthesizes the in-group sounds received from the sound input device of the each information terminal within the group to generate the single input sound,
the removing self-adapts a transfer function of the sound output device and the sound input device to minimize the echo component, with reference to the external sound transmitted through the external network, and subtracts an antiphase of the external sound processed through the self-adapting from the input sound synthesized by the synthesizing.

6. The computer program product of claim 4, further comprising
specifying whether to cause the each information terminal within the group connected via the internal network to function as a master terminal or a slave terminal configured to transmit a sound form the sound input device to the master terminal via the internal network, wherein
the master terminal comprises the first receiving, the first outputting, the second receiving, the synthesizing, the removing, and the second outputting, and
the slave terminal comprises none of the first receiving, the first outputting, the second receiving, the synthesizing, the removing, and the second outputting.
